(19) United States
(12) Patent Application Publication
(10) Pub. No.: US 2011/0005189 A1
(43) Pub. Date: Jan. 13, 2011

(54) Active Control of Flame Holding and Flashback in Turbine Combustor Fuel Nozzle

(75) Inventors: Jong Ho Uhm, Simpsonville, SC (US); Willy Steve Ziminsky, Simpsonville, SC (US); Christian Xavier Stevenson, Inman, SC (US)

Correspondence Address: GE Energy-Global Patent Operation;Fletcher Yoder PC, P.O. Box 692289, Houston, TX, 77269-2289, US

(73) Assignee: GENERAL ELECTRIC COMPANY, Schenectady, NY (US)

(21) Appl. No.: 12/499,772

(22) Filed: Jul. 8, 2009

(51) Int. Cl. F02C 9/00; F02C 1/00

(52) U.S. Cl. 60/39.281; 60/748

(57) ABSTRACT

A system includes a turbine combustor fuel nozzle. The turbine combustor fuel nozzle includes a swirl vane. The turbine combustor fuel nozzle also includes an injection hole configured to inject fluid in a downstream region of the swirl vane. The injection of fluid in a downstream region of the swirl vane may be in response to detection of a condition indicative of a flame inside the turbine combustor fuel nozzle.

### STATEMENT REGARDING FEDERALLY SPONSORED RESEARCH & DEVELOPMENT

This invention was made with Government support under contract number DE-FC26-05NT42643 awarded by the Department of Energy. The Government has certain rights in the invention.

### BACKGROUND OF THE INVENTION

The subject matter herein relates to fuel nozzles for gas turbine engines. More particularly, the disclosed subject matter relates to elimination of flashback and flame holding in conjunction with fuel nozzles.

A gas turbine engine combusts a mixture of fuel and air to generate hot combustion gases, which in turn drive one or more turbines. In particular, the hot combustion gases force turbine blades to rotate, thereby driving a shaft to rotate one or more loads, e.g., electrical generator. As appreciated, a flame develops in a combustion zone having a combustible mixture of fuel and air. Unfortunately, the flame can potentially propagate upstream from the combustion zone into the fuel nozzle, which can result in damage due to the heat of combustion. This phenomenon is generally referred to as flashback. Likewise, the flame can sometimes develop on or near surfaces, which can also result in damage due to the heat of combustion. This phenomenon is generally referred to as flame holding. For example, the flame holding may occur on or near a fuel nozzle in a low velocity region. In particular, an injection of a fuel flow into an air flow may cause a low velocity region near the injection point of the fuel flow, which can lead to flame holding.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a turbine combustor fuel nozzle, comprising a swirl vane, and an injection hole configured to inject fluid in a downstream region of the swirl vane in response to detection of a condition indicative of a flame inside the turbine combustor fuel nozzle.

In a second embodiment, a system includes a turbine combustor fuel nozzle, comprising an air path, a fuel path, a fuel-air mixture region receiving air from the air path and receiving fuel from the fuel path, and an fluid injection hole configured to inject fluid in the fuel-air mixture region in response to detection of a condition indicative of a flame inside the turbine combustor fuel nozzle.

In a third embodiment, a system includes a fuel nozzle flame sensor configured to detect a condition indicative of a flame inside a turbine combustor fuel nozzle, and a fuel nozzle flame controller configured to control an injection of a fluid into the turbine combustor fuel nozzle in response to a signal from the fuel nozzle flame sensor indicative of the condition.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 a schematic block diagram a gas turbine system in accordance with an embodiment of the present technique;

FIG. 2 is a cutaway side view of a gas turbine engine, as shown in FIG. 1, in accordance with an embodiment of the present technique;

FIG. 3 is a cutaway side view of a combustor of the gas turbine engine, as shown in FIG. 2, illustrating multiple fuel nozzles in accordance with an embodiment of the present technique;

FIG. 4 is a block diagram of a fuel nozzle, as shown in FIG. 3, in accordance with an embodiment of the present technique; and

FIG. 5 is a perspective cutaway view of a premixer of the fuel nozzle, as shown in FIG. 4, in accordance with certain embodiments of the present technique; and

FIG. 6 is a perspective cutaway view of the fuel nozzle, as shown in FIG. 3, in accordance with an embodiment of the present technique.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

In certain embodiments, as discussed in detail below, a gas turbine engine includes one or more fuel nozzles with fluid injection holes (e.g., injection holes) to resist thermal damage associated with flashback and/or flame holding. In particular, each fuel nozzle may include a fuel-air premixer having a plurality of swirl vanes disposed in a circumferential arrangement in an air flow path. The fuel nozzles may also include fluid injection holes (e.g., air injection holes) in a crossflow or angled flow relative to the longitudinal axis of the fuel nozzle and direction of main air flow through the fuel nozzle. For example, the fluid (e.g., air) injection holes may be located on the center body (e.g., hub) and the outer wall (e.g., shroud) of the fuel nozzle such that the holes direct air radially inward and radially outward relative to the longitudinal axis. Furthermore, the injection holes may be located immediately before each swirl vane trailing edge in the fuel nozzle. The injection holes improve the flame holding margin and reduce the possibility of flashback by blowing the flame out whether it anchors on the trailing edge of the swirl vane or behind the fuel outlet. This may be performed by steady air injection or modulation of air passing through the injection holes. Each method may disturb the entire flame stabilized behind the fuel hole by dividing the flame into at least two regions at the vane trailing edge or by fluttering it. Therefore, the injected air may detach the flame by weakening its energy and, thus, stabilizing the flame at the combustor. Also, the injected air may reduce the temperature in flame holding regions to eliminate the possibility of the re-ignition at those locations. The injection of fluid may reduce low velocity regions, that is, stagnant regions where flame may occur, through high velocity injection of fluids into the low velocity region. This may create a high velocity region where flame is not likely to occur and/or remain.

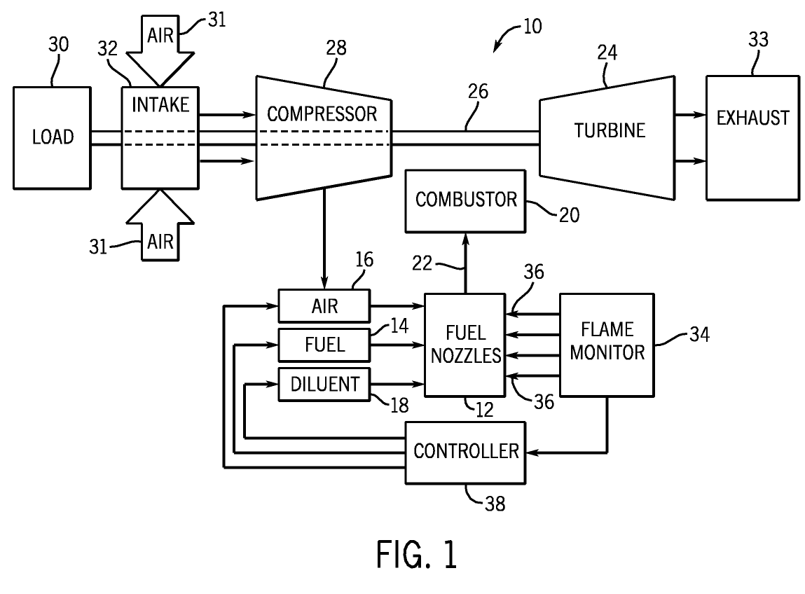

Turning now to the drawings and referring first to FIG. 1, a block diagram of an embodiment of a turbine system 10 is illustrated. The diagram includes one or more fuel nozzles 12, a fuel supply 14, an air supply 16, a diluent supply 18, and a combustor 20. As depicted, fuel supply 14 routes a liquid fuel or gas fuel, such as natural gas, to the turbine system 10 through a fuel nozzle 12 into the combustor 20. After mixing with pressurized air, shown by arrow 22, ignition occurs in the combustor 20 and the resultant exhaust gas causes blades within turbine 24 to rotate. The coupling between blades in turbine 24 and shaft 26 causes rotation of shaft 26, which is also coupled to several components throughout the turbine system 10, as illustrated. For example, the illustrated shaft 26 is drivingly coupled to a compressor 28 and a load 30. As appreciated, load 30 may be any suitable device that may generate power via the rotational output of turbine system 10, such as a power generation plant or a vehicle.

Air supply 31 may route air via conduits to air intake 32, which then routes the air into compressor 28. Compressor 28 includes a plurality of blades drivingly coupled to shaft 26, thereby compressing air from air intake 32 and routing it to fuel nozzles 12 and combustor 20, via air supply 16. At this juncture, diluent may also be routed to fuel nozzles 12 from the diluent source 18. The diluent may be, for example, an inert gas such as nitrogen that may aid in reducing undesirable emissions during combustion of the air/fuel mixture, or may aid in generating proper pressure levels for combustion in the combustor. Alternatively, the diluent may be water or another fluid. Fuel nozzle 12 may then mix the pressurized air and fuel (as well as the diluent, if needed), to produce an optimal mix ratio for combustion, e.g., a combustion that causes the fuel to more completely burn so as not to waste fuel or cause excess emissions. As a result of this combustion, exhaust gasses are generated that pass through turbine 24 and exit the system 10 at exhaust outlet 33. As discussed in detail below, an embodiment of the fuel nozzles 12 include at least one fluid injection hole (e.g., air injection hole) configured to inject fluid (e.g., air) in a downstream region of the swirl vane in response to detection of a condition indicative of a flame inside the turbine combustor fuel nozzle 12.

The detection of a condition indicative of a flame inside the turbine combustor fuel nozzle 12 may be registered by a flame monitor 34 connected to one or more sensors 36, (e.g., flame sensors). The sensors 36 may be pressure sensors for detecting changes in pressure inside of the fuel nozzles 12, thermal sensors for detecting changes in temperature in the fuel nozzles 12, and/or optical sensors for detecting changes in light in the fuel nozzles 12. In this manner, the sensors 36 may sense conditions indicative of either flashback or flame holding in the fuel nozzles 12. The sensors 36 may transmit signals to flame monitor 34 in response to the conditions of flame to the flame monitor 34.

Flame monitor 34 may be, for example, an application specific integrated circuit (ASIC) or other detection device that may receive the signals from the sensors 36 and may generate an indication that a flame has been detected in the fuel nozzles 12. This indication may be transmitted to a controller 38. The controller 38 may receive the indication of a detected flame in the fuel nozzles 12 from the flame monitor 34. The controller 38 may, for example, be a processor or an ASIC. In one embodiment, the flame monitor 34 and the controller 38 may be parts of a single processor. The controller 38 may, for example, operate to change conditions that affect the fuel nozzle 12. For example, the controller 38 may operate to increase or decrease the fuel supplied to the fuel nozzles 12 via adjustment of fuel supply 14, increase or decrease the air supplied to the fuel nozzles 12 via adjusting the air supply 16, and/or increase or decrease the diluent supplied to the fuel nozzles 12 via adjustment of the diluents source 18. By adjusting the components mixed in the fuel nozzle, the controller 38 may change the combustion conditions in the combustor 20, thus causing the extinguishment of the flame detected in one or more of the fuel nozzles 12. Furthermore, the controller 38 may selectively control one or more fluid injection holes (e.g., air, fuel, diluent, etc.) specifically oriented to reduce or eliminate conditions conducive to flashback or flame holding, or an actual event of flashback or flame holding. For example, as discussed below, the controller 38 may selectively activate and/or modulate fluid flow through these fluid injection holes to eliminate low velocity regions, create a crossflow, or generally disturb and blow out in flame inside the fuel nozzle 12.

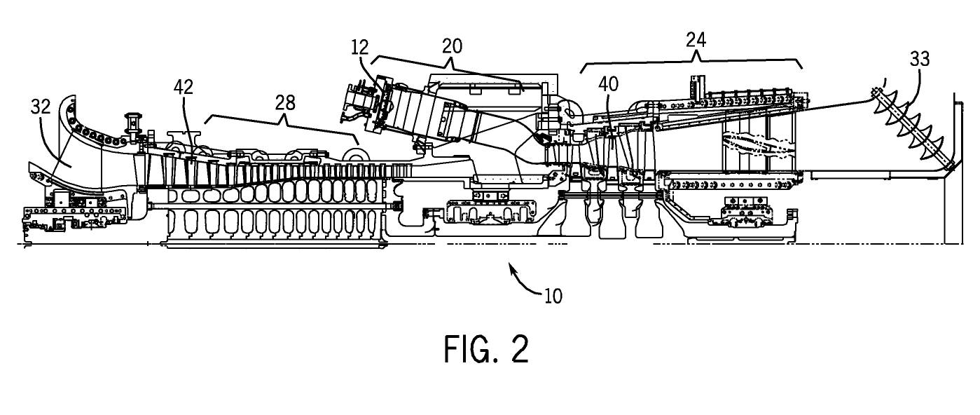

FIG. 2 illustrates a cross sectional side view of an embodiment of the turbine system 10 schematically depicted in FIG. 1 that may utilize fluid injection holes as described above. The turbine system 10 includes one or more fuel nozzles 12 located inside one or more combustors 20. In operation, air enters the turbine system 10 through the air intake 32 and may be pressurized in the compressor 28. The compressed air may then be mixed with fuel for combustion within combustor 20. For example, the fuel nozzles 12 may inject a fuel-air mixture into the combustor 20 in a suitable ratio for optimal combustion, emissions, fuel consumption, and power output. The combustion generates hot pressurized exhaust gases, which then drive one or more blades within the turbine 24 to rotate the shaft 26 and, thus, the compressor 28 and the load 30. The rotation of the turbine blades 40 causes rotation of the shaft 26, thereby causing blades 42 within the compressor 28 to draw in and pressurize the air received by the intake 32.

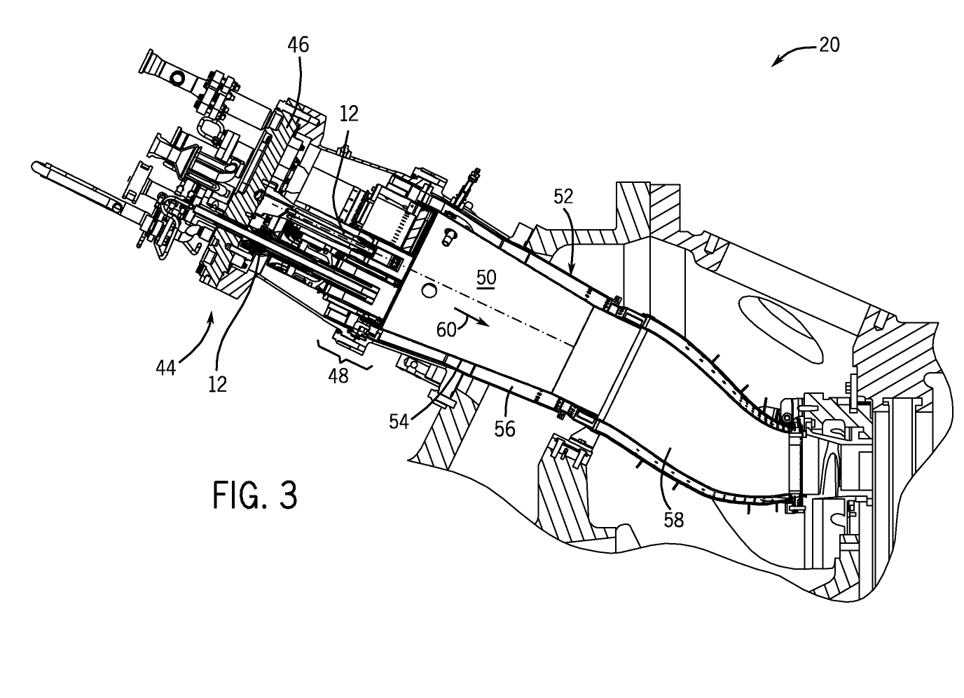

FIG. 3 shows a cutaway side view of an embodiment of combustor 20 having a plurality of fuel nozzles 12 that may each utilize the fluid injection holes to eliminate low velocity regions, create a crossflow, or generally disturb and blow out in flame inside the fuel nozzle 12. In certain embodiments, a head end 44 of a combustor 20 includes an end cover 46. Additionally, head end 44 of the combustor 20 may include a combustor cap assembly 48, which closes off the combustion chamber 50 and houses the fuel nozzles 12. The fuel nozzles 12 route fuel, air, and other fluids to the combustor 20. In the diagram, a plurality of fuel nozzles 12 are attached to end cover 46, near the base of combustor 20, and pass through the combustor cap assembly 48. For example, the combustor cap assembly 48 receives one or more fuel nozzles 12 and creates a boundary from the combustion. Each fuel nozzle 12 facilitates mixture of pressurized air and fuel and directs the mixture through the combustor cap assembly 48 into the combustion chamber 50 of the combustor 20. The fuel-air mixture may then combust in the combustion chamber 50, thereby creating hot pressurized exhaust gases. These pressurized exhaust gases drive the rotation of blades 40 within turbine 24. Combustor 20 includes a flow sleeve 52 and a combustor liner 54 forming the combustion chamber 50. In certain embodiments, flow sleeve 52 and liner 54 are coaxial or concentric with one another to define a hollow annular space 56, which may enable passage of air for cooling and entry into the combustion zone 50 (e.g., via perforations in liner 54 and/or fuel nozzles 12). The design of the liner 54 provides optimal flow of the fuel-air mixture to transition piece 58 (e.g., converging section) along directional line 60 towards turbine 24. For example, fuel nozzles 12 may distribute a pressurized fuel-air mixture into combustion chamber 50, wherein combustion of the mixture occurs. The resultant exhaust gas flows through transition piece 58 along directional line 60 to turbine 24, causing blades 40 of turbine 24 to rotate, along with the shaft 26.

During this process, a flame generated via the combustion in the combustion chamber 50 may flashback, (e.g., the flame may propagate from the combustion chamber 50 into one or more of the fuel nozzles 12. To aid in the removal of this flame from the fuel nozzles, the controller 38 may be utilized in conjunction with fluid (e.g., air, fuel, water, diluent, etc.) injection holes to reduce or eliminate the conditions conductive to flashback and flame holding in the fuel nozzle 12. That is, the fluid injection holes may, for example, reduce low velocity regions where flame may occur through high velocity injection of fluids into the low velocity region to create a high velocity region where flame is not likely to be sustained.

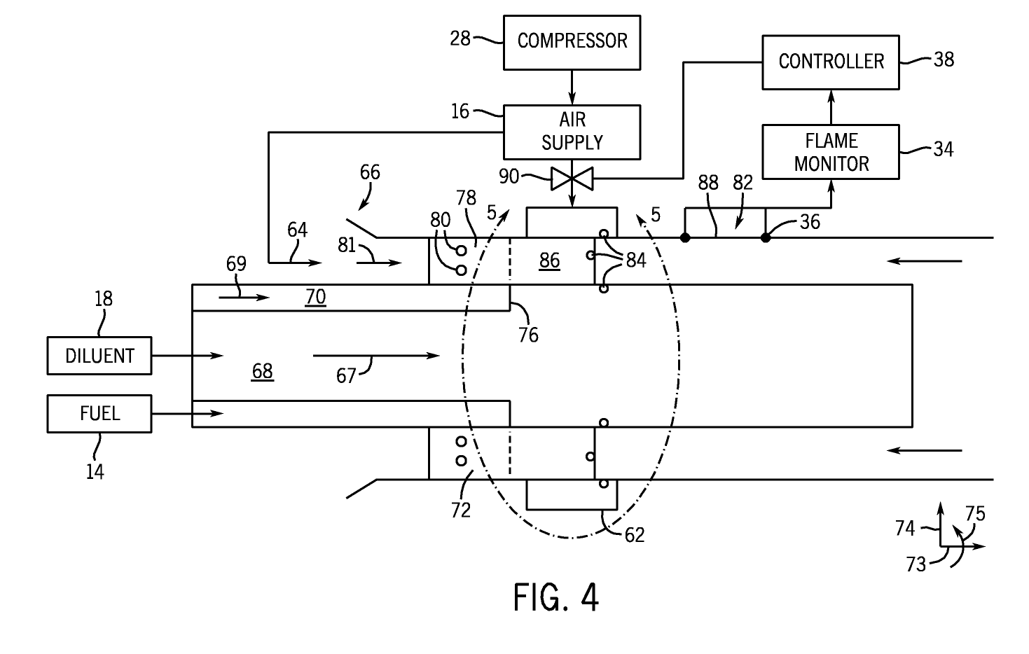

FIG. 4 is a block diagram of fuel nozzle 12, as shown in FIG. 3, as well as compressor 28, air supply 16, flame monitor 34, sensors 36, and controller 38. As described above, the compressor 28 may provide compressed air to the air supply 16, which may be routed to both a plenum 62 as well as to a nozzle air intake 64 in an upstream 66 portion of the nozzle 12. Additionally diluent may be routed from the diluent source 18 along a fluid path, illustrated by directional arrow 67, in a center body portion 68 (e.g., annular body) of the nozzle 12. This fluid path 67 may operate to cool fuel passing from the fuel supply 14 along a fuel path, illustrated by directional arrow 69, in a fuel passage 70 (e.g., annular passage) located in the center body 68 of the nozzle 12. As will be discussed below, the diluent, fuel, and air may mix to form a combustion mixture (e.g., a fuel-air mixture) for combustion in the combustion chamber 50.

As illustrated, the nozzle 12 may include one or more swirl vanes 72. Each swirl vane 72 may be a hollow body, e.g., a hollow airfoil shaped body, which may induce a swirling flow within the fuel nozzle 12. Thus, the fuel nozzle 12 may be described as a swozzle in view of this swirl feature. It should be noted that various aspects of the fuel nozzle 12 may be described with reference to an axial direction or axis 73, a radial direction or axis 74, and a circumferential direction or axis 75. For example, the axis 73 corresponds to a longitudinal centerline or lengthwise direction, the axis 74 corresponds to a crosswise or radial direction relative to the longitudinal centerline, and the axis 75 corresponds to the circumferential direction about the longitudinal centerline.

The fuel may flow axially 73 through the fuel passage 70 until it abuts wall 76 in the fuel passage 70. Upon abutting wall 76, the fuel may radially 74 flow into a fuel compartment 78 of the hollow swirl vane 72 and may exit the fuel compartment 78 via fuel holes 80 (e.g., fuel injection hole) into a mixing region surrounding the swirl vane 72. In this mixing region, the fuel interacts with compressed air routed from the air supply 16 moving along directional arrow 81. As described above, this fuel-air mixture may be swirled by the swirl vane 72 to aid in mixing of the fuel and air for proper combustion.

As indicated above, flashback may occur in the fuel nozzle 12, specifically in the downstream portion 82 of the fuel nozzle 12. To reduce the occurrence of flashback, fluid injection holes 84 (e.g., air injection holes) may be utilized to inject fluid (e.g., air) into the downstream portion 82 of the fuel nozzle 12. These injection holes 84 may, for example, have a diameter of approximately less 80, 70, 60, 50, 40, 30, 20, or 10 percent the diameter of the fuel holes 80. The fluid injection holes 84 may be included in a fluid compartment 86 of the swirl vane 72, in the plenum 62, and/or in the center body 68 of the fuel nozzle 12. The fluid (e.g., air) injected from these holes 84 may be angled or crosswise with respect to directional flow line 81. It should be noted that the holes 84 may inject, for example, air into the fuel nozzle 12. Alternatively, other fluids such as nitrogen, water, and/or fuel may be utilized in place of or in conjunction with the air injected via holes 84. Thus, the fluid injected from immediately prior to swirl vane trailing edge on concave face and from center body and outer wall may enter the downstream portion 82 of the nozzle 12 at an angle of approximately less than 20 degrees and 30 to 90 degrees relative to the directional flow 81 of the main air along directional arrow 81. In an embodiment, the fluid may enter the downstream portion 82 of the nozzle 12 at an angle of approximately less than 20 degrees or approximately between 30 to 90 degrees relative to the directional flow 81 of the main air along directional arrow 81. As may be seen, air delivery to the holes 84 on the center body 68, (e.g., hub), may be through the fluid compartment 86 of the vane 72, while the plenum 62 may provide air to the holes 84 on the outer wall 88 (e.g., annular wall) of the fuel nozzle 12. It should be noted that the center body 68 and the outer wall 88 may be coaxial or concentric with one another. The holes 84 on the center body 68 may receive fluid via the diluent travelling along directional line 67. Furthermore, air delivery to the holes 84 on the center body 68 may be coupled to a delivery tube, which is connected to an air delivery tube of the outer wall 88 holes 84. In one embodiment, an adjustable valve may lie between the delivery tubes that may be controlled by the controller 38 to adjust the fluid flow (e.g., airflow) rate for each delivery tube upon reception of an indication from the flame monitor 34 that a flame has been detected in the fuel nozzles 12. The controller 38 may also operate a main air valve 90 to control the air flow into both the upstream portion 66 of the fuel nozzle 12 as well as the air (or fluid) passed to the plenum 62 for transmission to the holes 84.

It should be noted that the fluid (or air) may be continuously flowing through the holes 84, or the air may be modulated, (e.g., pulsed). Alternatively, the fluid may be in an “off” state, and then turned “on” when a flame is detected. If the fluid is continuously flowing through the holes 84, it may be increased when a high velocity jet is required to extinguish a flame. For example, the velocity of the flow through the jets may be increased to approximately 1.25, 1.3, 1.5, 1.75, 2, 2.5, 3, 3.5, or greater times the speed of the main air flow along directional line 81. Similarly, if the fluid is introduced through the holes 84 when previously not flowing, the fluid may flow at a velocity of approximately 1.05 or greater times the speed of the main air flow along directional line 81.

If the fluid from the holes 84 is pulsed, it may be modulated at a frequency of approximately less than 20 Hz. The modulation of the fluid exiting the holes 84 may be approximately less than 10 Hz. In other embodiments, the modulation of the fluid exiting the holes 84 may be approximately 1, 2, 3, 4, 5, 6, 7, 8, 9, or 10 Hz. This modulation may be sufficient to change the flame conditions in the nozzle to detach any flame from the downstream region 82 of the fuel nozzle, for example, downstream of the vane 72. It should also be noted that the speed of the fluid exiting the holes, in either a continuous or modulated manner, may be approximately 1.25, 1.3, 1.5, 1.75, 2, 2.5, 3, 3.5, or greater times the speed of the of the main air flow. Additionally, the speed of the fluid exiting the holes, in either a continuous or modulated manner, may be approximately 1.3 to 3 times the speed of the of the main air flow.

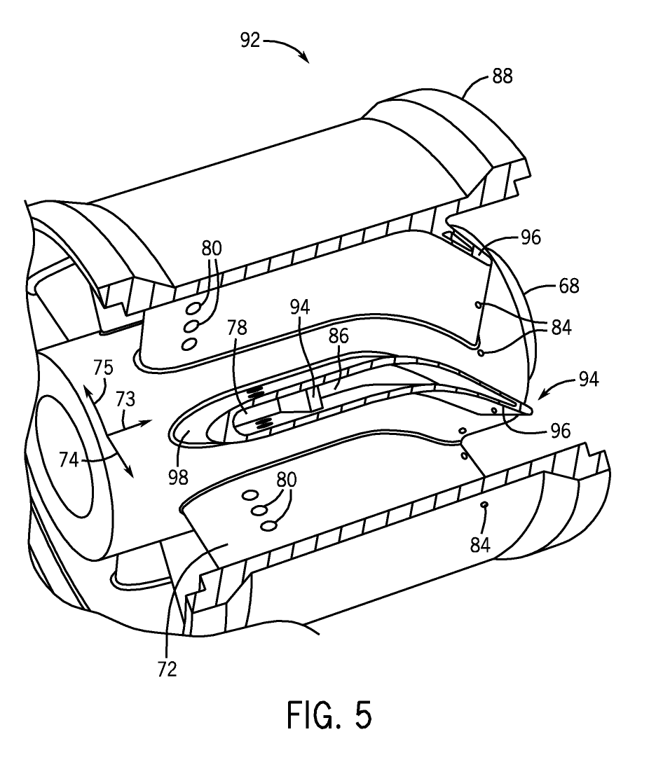

FIG. 5 is a perspective cutaway view of an embodiment of a premixer section 92 of the fuel nozzle 12 taken within arcuate line 5-5 of FIG. 4. The premixer 92 includes the swirl vanes 72 disposed circumferentially 75 around the nozzle center body 68, wherein the vanes 72 extend radially 74 outward from the nozzle center body 68 to the outer wall 88. As illustrated, each swirl vane 72 is a hollow body, e.g., a hollow airfoil shaped body, having a fuel compartment 78, a fluid compartment 86, and a divider 94 between the compartments 78 and 86. Fuel exits the fuel compartment 78 via fuel holes 80.

The controller 38 may operate to prevent or actively eliminate flame in the nozzle 12. For example, in the event of flashback or flame holding in the fuel nozzle 12 detected by the flame monitor 34, the controller 38 may adjust air flowing through the injection holes 84 via one or more valves, as previously discussed. The injection holes 84 may provide an extinguishing force that may operate as a corrective measure to eliminate the flashback or flame holding. In particular, thermal damage may occur at the downstream end portion 96 (e.g., downstream tip) of the swirl vane 72. Thus, by locating the injection holes 84 proximate to this end portion 96, the thermal damage to of the swirl vane 72 may be reduced or eliminated and the possibility of any further damage to the fuel nozzle 12 (e.g., further upstream 66) may also be reduced.

In the illustrated embodiment, the premixer 92 includes eight swirl vanes 72 equally spaced at 45 degree increments about the circumference 75 of the nozzle center body 68. In certain embodiments, the premixer 92 may include any number of swirl vanes 72 (e.g., 8 or 10) disposed at equal or different increments about the circumference 75 of the nozzle center body 68. The swirl vanes 72 are configured to swirl the flow, and thus induce fuel-air mixing. As illustrated, each swirl vane 72 bends or curves from the upstream end portion 98 to the downstream end portion 96. In particular the upstream end portion 98 is generally oriented in an axial direction along the axis 73, whereas the downstream end portion 96 is generally angled, curved, or directed away from the axial direction along the axis 73. For example, the downstream end portion 96 may be angled relative to the upstream end portion 98 by an angle of approximately 5 to 60 degrees, or approximately 10 to 45 degrees. As a result, the downstream end portion 96 of each swirl vane 72 biases or guides the flow into a rotational path about the axis 73 (e.g., swirling flow). This swirling flow enhances fuel-air mixing within the fuel nozzle 12 prior to delivery into the combustor 20.

Additionally, one or more injection holes 84 may be disposed on the vanes 72 at the downstream end portion 96, as well as on the center body 68 and/or outer wall 88. For example, these injection holes 84 may be approximately 40 mil diameter (for example, 80% of 50 mil diameter fuel hole), 45, or 50 mils in diameter. Each swirl vane 72 may include 1, 2, 3, or more injection holes 84 and in the case of 10 swirl vanes there may be 10 on the vane trailing edge or more injection holes 84 on the center body 68 and or on the outer wall 88 (for example, inside of the plenum 62 and along the outer wall 88).

Furthermore, each injection hole 84 may be oriented in an axial direction along the axis 73, and/or in a radial direction along the axis 74. In other words, each injection hole 84 may have a simple or compound angle relative to a surface of the swirl vane 72 and/or the center body 68 and outer wall 88. For example, the injection holes 84 may cause the air to flow into the premixer 92 at an angle of approximately less than 20 degrees and 30 to 90 degrees with respect to the directional flow of the main air 81. Angling the injection holes 84 in this manner may allow for more complete extinguishing of any flames in the premixer 92. Thus the injection of fluid via the injection holes 84 may be parallel to the main fuel-air flow, or crosswise relative to the longitudinal axis and to the main fuel-air flow. In this manner, the holes 84 may reduce or eliminate conditions conducive to flashback and flame holding (e.g., low velocity regions) via injection of air, water, nitrogen, fuel, or another fluid into the nozzle 12.

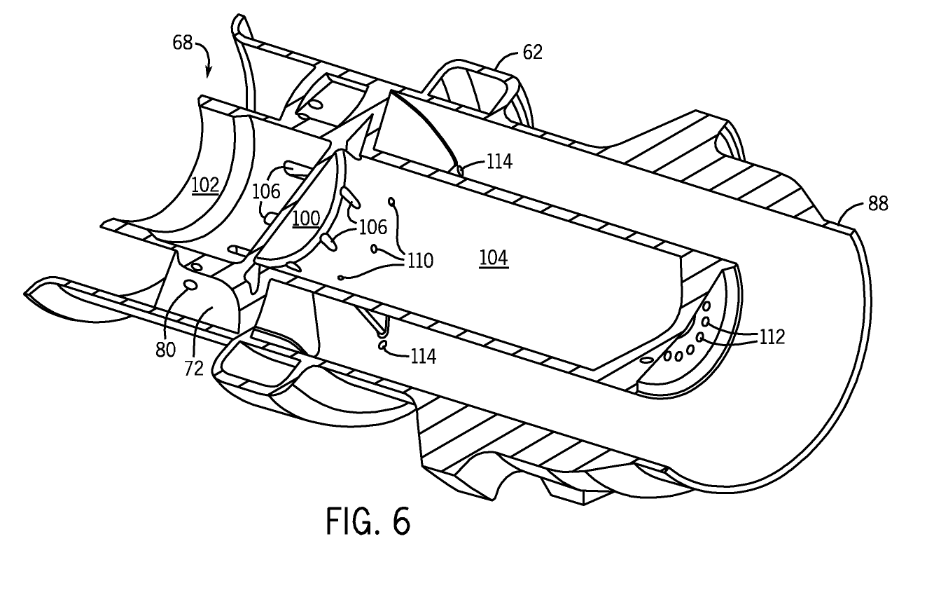

FIG. 6 is a perspective cutaway view of the fuel nozzle 12. As shown in FIG. 6, the fuel nozzle may include the plenum 62, the center body 68, vanes 72, fuel holes 80, and an outer wall 88. The center body 68 may include a divider 100 that separates a fuel compartment 102 from a fluid compartment 104. The fuel compartment 102 may receive fuel from the fuel supply 14 and may route the fuel through the fuel outlets 106 to the vanes 72, and then out through holes 80 as previously described. The fluid compartment 104 may receive air from the plenum 62 via inlets 108 coupled to the fluid compartment 86 of the vane 72. In this manner, fluid (e.g., air) may flow from the plenum 62, through the vanes 72, and into the fluid compartment 104. The fluid may travel along an axial direction 73 through the fluid compartment 104, exiting the fluid compartment 104 via both hub side holes 110, (e.g., which may be akin to the injection holes 84 in the center body 68 previously discussed with respect to FIG. 4), and center body tip holes 112, for continued mixing with the fuel-air mixture of the nozzle 12. Additionally, shroud side holes 114 (e.g., which may be akin to the injection holes 84 in the outer wall 88 previously discussed with respect to FIG. 4), may be utilized to inject fluid into the fuel nozzle 12 in either a continuous or modulated manner to dissipate flames (as described above). In this manner, all of the fluid to be injected into the fuel nozzle 12 to extinguish flames in the fuel nozzle 12 may be supplied by the plenum 66.

As such, holes 84 may inject fluid such as air, diluent (e.g., water, nitrogen, etc.), and/or fuel in a substantially parallel or in a longitudinally crosswise manner to the direction of the main fuel-air flow through the nozzle. The injection may occur from the center body 68, the vanes 72, and/or the outer wall 88 (e.g., in the plenum 62). The fluid may, for example, be directed radially inward, radially outward, axially, or at a particular angle relative to the longitudinal axis of the fuel nozzle 12. Additionally, the controller 38 may trigger the injection only when flames are detected in particular regions of the fuel nozzle 12 and/or the injection may always be occurring and may be increased in velocity when flames in those regions are detected. That is, the controller may increase the flow through the holes at a baseline flow rate, (e.g., increase the velocity of the fluid injected through the holes 84 by approximately 50%, 100%, 150%, 200%, or more), or the controller may control the modulation (e.g., pulsing) of the fluid flow through the holes 84.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system, comprising:
a turbine combustor fuel nozzle, comprising:
a swirl vane; and
an injection hole configured to inject fluid in a downstream region of the swirl vane in response to detection of a condition indicative of a flame inside the turbine combustor fuel nozzle.

2. The system of claim 1, wherein the injection hole is disposed on the swirl vane at the downstream region having a trailing edge of the swirl vane.

3. The system of claim 1, wherein the injection hole is disposed on a center body of the turbine combustor fuel nozzle, the swirl vane is disposed about the center body, and the injection hole is directed radially outward from an axis of the turbine combustor fuel nozzle.

4. The system of claim 1, wherein the injection hole is disposed on an outer body of the turbine combustor fuel nozzle, the swirl vane is disposed inside the outer body, and the injection hole is directed radially inward from an axis of the turbine combustor fuel nozzle.

5. The system of claim 1, wherein the injection hole is configured to modulate injection of the fluid.

6. The system of claim 1, wherein the injection hole is configured to inject the fluid at a second velocity at least greater than approximately 1.3 times a first velocity of a fuel-air mixture passing through the turbine combustor fuel nozzle along the swirl vane.

7. The system of claim 1, wherein the turbine combustor fuel nozzle comprises a center body, the swirl vane disposed about the center body, an outer tubular wall disposed about the swirl vane and the center body, and a plenum disposed about the outer tubular wall, wherein the swirl vane comprises a fuel injection hole upstream from a trailing edge of the swirl vane, the injection hole comprises a first injection hole disposed directly on the swirl vane, the injection hole comprises a second injection hole disposed on the center body, and the injection hole comprises a third injection hole disposed on the outer tubular wall, wherein the first, second, and third injection holes receive fluid from the plenum.

8. The system of claim 7, wherein the first, second, and third injection holes have a first diameter at least less than approximately 80 percent of a second diameter of the fuel injection hole.

9. A system, comprising:
a turbine combustor fuel nozzle, comprising:
an air path;
a fuel path;
a fuel-air mixture region receiving air from the air path and receiving fuel from the fuel path; and
an fluid injection hole configured to inject fluid in the fuel-air mixture region in response to detection of a condition indicative of a flame inside the turbine combustor fuel nozzle.

10. The system of claim 9, comprising a swirl vane disposed in the fuel-air mixture region.

11. The system of claim 9, wherein the fluid injection hole is oriented crosswise to an axial flow direction along an axis of the turbine combustor fuel nozzle.

12. The system of claim 11, wherein the fluid injection hole is directed at an angle of between approximately 30 to 90 degrees relative to the axial flow direction along the axis of the turbine combustor fuel nozzle.

13. The system of claim 9, wherein the fluid injection hole is directed at an angle of at least less than approximately 20 degrees from angled vane concave face relative to an axis of an axial flow direction along an axis of the turbine combustor fuel nozzle.

14. The system of claim 9, comprising a sensor configured to detect the condition indicative of the flame, wherein the sensor is disposed inside the turbine combustor fuel nozzle.

15. The system of claim 14, wherein the sensor comprises a pressure sensor, a temperature sensor, an optical sensor, or a combination thereof.

16. The system of claim 9, wherein the fluid injection hole comprises an injection hole configured to inject air as the fluid at a velocity greater than a fuel-air flow passing through the fuel-air mixture region, or at a modulated frequency, or a combination thereof.

17. The system of claim 9, wherein the fluid injection hole is configured to inject a non-combustible fluid as the fluid.

18. The system of claim 9, comprising a combustor having the turbine combustor fuel nozzle, a turbine engine having the turbine combustor fuel nozzle, or a combination thereof.

19. A system, comprising:
a fuel nozzle flame sensor configured to detect a condition indicative of a flame inside a turbine combustor fuel nozzle; and
a fuel nozzle flame controller configured to control an injection of a fluid into the turbine combustor fuel nozzle in response to a signal from the fuel nozzle flame sensor indicative of the condition.

20. The system of claim 19, comprising an adjustable valve that regulates the injection of the fluid into the fuel nozzle, wherein the fuel nozzle flame controller is configured to trigger the injection of the fluid via control of the adjustable valve.
